(19) United States
(12) Patent Application Publication
(10) Pub. No.: US 2026/0184959 A1
(43) Pub. Date: Jul. 2, 2026

(54) POLYAMIC ACID COMPOSITION, POLYIMIDE, POLYIMIDE FILM, LAMINATE, ELECTRONIC DEVICE, AND METHOD OF PRODUCING POLYAMIC ACID COMPOSITION

(71) Applicant: KANEKA CORPORATION, Osaka (JP)

(72) Inventor: Hirofumi Nakayama, Otsu-shi (JP)

(73) Assignee: KANEKA CORPORATION, Osaka (JP)

(21) Appl. No.: 19/550,737

(22) Filed: Feb. 26, 2026

Related U.S. Application Data
(63) Continuation of application No. PCT/JP2024/030395, filed on Aug. 27, 2024.

(30) Foreign Application Priority Data
Aug. 30, 2023 (JP) 2023-140304

(51) Int. Cl. C09D 179/08; C03C 17/32; C08G 73/10

(52) U.S. Cl. CPC C09D 179/08; C03C 17/32; C08G 73/1028; C08G 73/1067; C08G 73/1085

(57) ABSTRACT

The polyamic acid composition contains the polyamic acid, an organic solvent, an aminophenol, and a methyl aminobenzoate. The polyamic acid includes a 4-aminophenyl-4-aminobenzoate residue as a diamine residue. The content of the 4-aminophenyl-4-aminobenzoate residue is 70 mol % or more with respect to the total amount of diamine residues included in the polyamic acid. The content of the aminophenol is 1 ppm by mass or more and 30 ppm by mass or less with respect to the total amount of the sample. The content of the methyl aminobenzoate is 0.01 ppm by mass or more and 0.10 ppm by mass or less with respect to the total amount of the sample. The contents of aminophenol and methyl aminobenzoate are obtained by gas chromatography-mass spectrometry using a sample obtained by diluting the polyamic acid composition so that the concentration of the polyamic acid is 1 mass %.

### TECHNICAL FIELD

One or more embodiments of the present invention relate to a polyamic acid composition, a polyimide, a polyimide film, a laminate, an electronic device, and a method of producing a polyamic acid composition. One or more embodiments of the present invention further relate to an electronic device material in which a polyimide is used, a thin film transistor (TFT) substrate, a flexible display substrate, a color filter, a printed matter, an optical material, an image display device (more specifically, a liquid crystal display device, an organic electroluminescence (organic EL), an electronic paper, or the like), a 3D display, a solar cell, a touch panel, a transparent conductive film substrate, and an alternative material for a member in which glass is currently used.

### BACKGROUND

With rapid progress of displays such as liquid crystal displays, organic ELs, and electronic papers and electronic devices such as solar cells and touch panels, devices have been progressively made thinner, lighter, and more flexible. In these devices, a polyimide is used as a substrate material instead of a glass substrate.

In these devices, various electronic elements such as a thin film transistor and a transparent electrode are formed on a substrate, and formation of these electronic elements needs a high-temperature process. A polyimide has heat resistance sufficient to be adaptable to a high-temperature process, and has a thermal expansion coefficient (CTE) close to that of a glass substrate or an electronic element, so that internal stress is less likely to occur. Thus, a polyimide is suitable for a substrate material for a flexible display and the like.

An aromatic polyimide is generally yellowish-brown color due to intramolecular conjugation or formation of a charge transfer (CT) complex. In top-emission type organic ELs and the like, light is extracted from the opposite side of a substrate, and therefore the substrate is not required to have transparency, and a conventional aromatic polyimide has been used. However, in a case where light emitted from a display element is emitted through a substrate as in a transparent display, a bottom-emission type organic EL, or a liquid crystal display, or in a case where a sensor or a camera module is disposed on the back surface of a substrate in order to make a smartphone or the like a full-surface display (notchless), the substrate is also required to have high optical properties (more specifically, transparency and the like).

From such a background, there is a demand for a material that has heat resistance equivalent to that of an existing aromatic polyimide and is less colored and excellent in transparency.

Techniques of suppressing formation of a CT complex using an aliphatic monomer (Patent Documents 1 and 2), a technique of enhancing transparency by using a monomer having a fluorine atom (Patent Document 3), and a technique of enhancing transparency by using a monomer having a fluorene structure (Patent Document 4) are known as techniques for reducing coloration of a polyimide.

### PATENT DOCUMENTS

Patent Document 1: JP 2016-29177 A
Patent Document 2: JP 2012-41530 A
Patent Document 3: Taiwan Patent Application Publication No. 201713726
Patent Document 4: WO 2019/195148

As a result of verification by the present inventor, it has been found that when a polyamic acid composition described in any one of Patent Documents 1 to 4 is applied onto a support and the polyamic acid is imidized, the internal stress generated at the interface between the polyimide film and the support tends to be large. Hereinafter, the internal stress generated at the interface between a polyimide film and a support may be simply described as the “internal stress”. If the internal stress is large, application to an electronic device may be difficult.

The techniques described in Patent Documents 1 to 4 still have room for improvement in enhancing the transparency of a polyimide.

### SUMMARY

One or more embodiments of the present invention have been made in view of the above circumstances. One or more embodiments of the present invention are to provide a polyimide excellent in transparency while the internal stress is reduced, and a polyimide film, a laminate, and an electronic device that contain the polyimide. One or more embodiments of the present invention are also to provide a polyamic acid composition containing a polyamic acid as a precursor of the polyimide, and a method of producing the polyamic acid composition.

### <Aspects of the Invention>

An aspect of one or more embodiments of the present invention is as follows.
[1] Apolyamic acid composition including:
a polyamic acid;
an organic solvent;
an aminophenol; and
a methyl aminobenzoate, in which
the polyamic acid includes a 4-aminophenyl-4-aminobenzoate residue as a diamine residue,
a content of the 4-aminophenyl-4-aminobenzoate residue is 70 mol % or more with respect to a total amount of diamine residues included in the polyamic acid,
a content of the aminophenol, obtained by gas chromatography-mass spectrometry using a sample obtained by diluting the polyamic acid composition to a concentration of the polyamic acid of 1 mass %, is 1 ppm by mass or more and 30 ppm by mass or less with respect to a total amount of the sample, and
a content of the methyl aminobenzoate, obtained by gas chromatography-mass spectrometry using a sample obtained by diluting the polyamic acid composition to a concentration of the polyamic acid of 1 mass %, is 0.01 ppm by mass or more and 0.10 ppm by mass or less with respect to a total amount of the sample.
[2] The polyamic acid composition according to [1], in which a Gardner color and a Hazen color, measured with a cell having an optical path length of 1 cm using a sample obtained by diluting the polyamic acid composition to a concentration of the polyamic acid of 1 mass %, are 0.3 or less and 10 or less, respectively.
[3] The polyamic acid composition according to [1] or [2], in which the polyamic acid includes one or more tetracarboxylic dianhydride residues selected from the group consisting of tetravalent organic groups represented by Chemical Formula (1) described below, tetravalent organic groups represented by Chemical Formula (2) described below, tetravalent organic groups represented by Chemical Formula (3) described below, tetravalent organic groups represented by Chemical Formula (4) described below, tetravalent organic groups represented by Chemical Formula (5) described below, tetravalent organic groups represented by Chemical Formula (6) described below, tetravalent organic groups represented by Chemical Formula (7) described below, tetravalent organic groups represented by Chemical Formula (8) described below, tetravalent organic groups represented by Chemical Formula (9) described below, and tetravalent organic groups represented by Chemical Formula (10) described below:

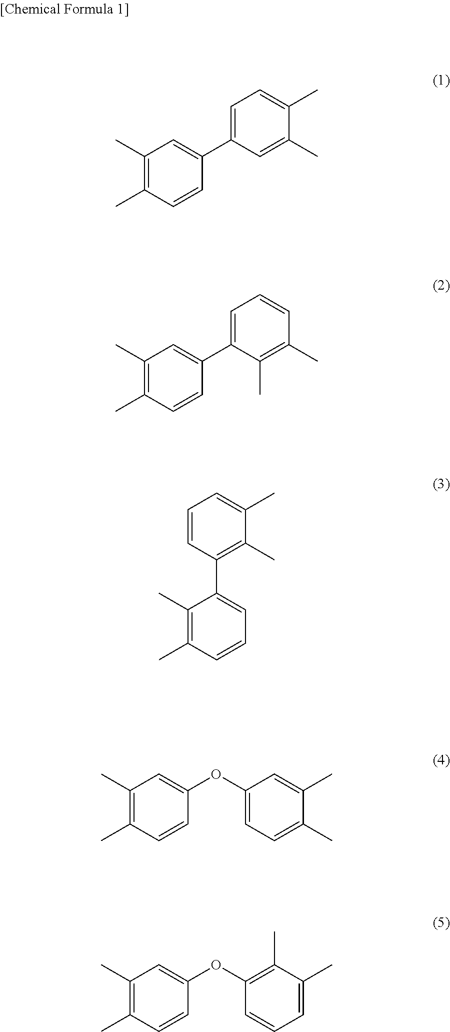

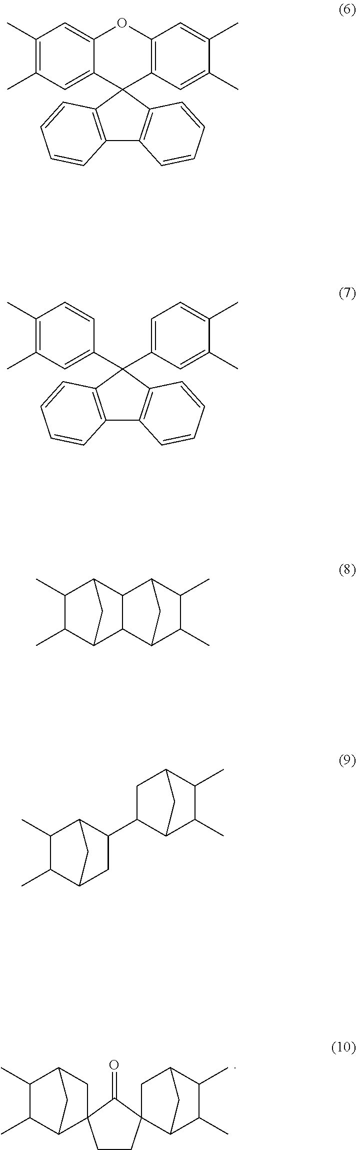

[4]A polyimide which is an imidized product of the polyamic acid contained in the polyamic acid composition according to any one of [1] to [3].
[5]A polyimide film including the polyimide according to [4].
[6] The polyimide film according to [5], having a yellowness index of 20 or less.
[7] The polyimide film according to [5] or [6], having a transmittance of light having a wavelength of 400 nm of 88% or more.
[8]A laminate including a support and the polyimide film according to any one of [5] to [7].
[9] The laminate according to [8], in which
the support is a glass substrate, and
an internal stress between the polyimide film and the glass substrate is 30 MPa or less.
[10] An electronic device including the polyimide film according to any one of [5] to [7] and an electronic element disposed on the polyimide film.
[11]A method of producing the polyamic acid composition according to any one of [1] to [3], the method including:
a step S1 of reacting a diamine with a tetracarboxylic dianhydride in an organic solvent, in which
the diamine contains 4-aminophenyl-4-aminobenzoate,
a content of the 4-aminophenyl-4-aminobenzoate is 70 mol % or more with respect to a total amount of the diamine,
the 4-aminophenyl-4-aminobenzoate is used as a raw material monomer containing an impurity and subjected to the step S1,
the impurity contains aminophenol and methyl aminobenzoate, and
a Gardner color and a Hazen color, measured with a cell having an optical path length of 1 cm using a 1 mass % N-methyl-2-pyrrolidone solution of the raw material monomer, are 3.0 or less and 200 or less, respectively.
[12] The method according to [11], in which
a content of the aminophenol in the raw material monomer is 0.60 mass % or less with respect to a total amount of the 4-aminophenyl-4-aminobenzoate, and
a content of the methyl aminobenzoate in the raw material monomer is 0.60 mass % or less with respect to the total amount of the 4-aminophenyl-4-aminobenzoate.

According to one or more embodiments of the present invention, it is possible to provide a polyimide excellent in transparency while the internal stress is reduced, and a polyimide film, a laminate, and an electronic device that contain the polyimide. According to one or more embodiments of the present invention, it is also possible to provide a polyamic acid composition containing a polyamic acid as a precursor of the polyimide, and a method of producing the polyamic acid composition.

### DETAILED DESCRIPTION

One or more embodiments of the present invention will be described in detail below, but the present invention is not limited to these embodiments. The academic documents and the patent documents mentioned in the present description are incorporated in the present description by reference in their entirety.

First, terms used in the present description will be described. The term “structural unit” refers to a repeating unit included in a polymer. The term “polyamic acid” refers to a polymer including a structural unit represented by General Formula (11) described below (hereinafter, sometimes described as “structural unit (11)”).

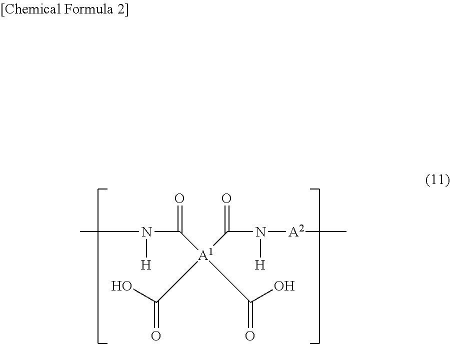

In General Formula (11), A¹ represents a tetracarboxylic dianhydride residue (tetravalent organic group derived from a tetracarboxylic dianhydride), and A² represents a diamine residue (divalent organic group derived from a diamine).

The content of the structural unit (11) with respect to all of the structural units included in the polyamic acid may be, for example, 50 mol % or more and 100 mol % or less, 60 mol % or more and 100 mol % or less, 70 mol % or more and 100 mol % or less, 80 mol % or more and 100 mol % or less, or 90 mol % or more and 100 mol % or less, or may be 100 mol %.

Hereinafter, the name of a compound may be followed by the term “-based” to collectively refer to the compound and its derivatives. The term “-based” following the name of a compound to express the name of a polymer means that repeating units of the polymer are derived from the compound or its derivative, unless otherwise specified. The tetracarboxylic dianhydride may be described as “acid dianhydride”.

Unless otherwise specified, the components, the functional groups, and the like shown in the present description may be used singly, or in combination of two or more kinds thereof.

### One or More Embodiments of Present Invention

The polyamic acid composition according to one or more embodiments contains the polyamic acid (hereinafter, sometimes described as “specific polyamic acid”), an organic solvent, an aminophenol, and a methyl aminobenzoate. The specific polyamic acid includes a 4-aminophenyl-4-aminobenzoate residue as a diamine residue. In the specific polyamic acid, the content of the 4-aminophenyl-4-aminobenzoate residue is 70 mol % or more with respect to the total amount (100 mol %) of diamine residues included in the specific polyamic acid. The content of the aminophenol is obtained by gas chromatography-mass spectrometry using a sample obtained by diluting the polyamic acid composition according to one or more embodiments so that the concentration of the specific polyamic acid is 1 mass %, and the content is 1 ppm by mass or more and 30 ppm by mass or less with respect to the total amount of the sample. The content of the methyl aminobenzoate is obtained by gas chromatography-mass spectrometry using a sample obtained by diluting the polyamic acid composition according to one or more embodiments so that the concentration of the specific polyamic acid is 1 mass %, and the content is 0.01 ppm by mass or more and 0.10 ppm by mass or less with respect to the total amount of the sample.

Examples of the diluent solvent for preparation of the sample (specifically, the sample used in determination of the content of the aminophenol and the content of the methyl aminobenzoate) include the same kind of organic solvent as the organic solvent contained in the polyamic acid composition.

Hereinafter, gas chromatography-mass spectrometry may be described as “GC/MS analysis”. The content of the aminophenol, obtained by a GC/MS analysis method using a sample obtained by diluting the polyamic acid composition so that the concentration of the polyamic acid is 1 mass %, (the content with respect to the total amount of the sample) may be simply described as “the content of the aminophenol in the polyamic acid composition”. The content of the methyl aminobenzoate, obtained by a GC/MS analysis method using a sample obtained by diluting the polyamic acid composition so that the concentration of the polyamic acid is 1 mass %, (the content with respect to the total amount of the sample) may be simply described as “the content of the methyl aminobenzoate in the polyamic acid composition”. The method of measuring the content of the aminophenol in the polyamic acid composition and the method of measuring the content of the methyl aminobenzoate in the polyamic acid composition are the same as or similar to the methods in Examples described below. 4-Aminophenyl-4-aminobenzoate may be described as “4-BAAB”.

A polyimide obtained from the polyamic acid including the 4-BAAB residue has a relatively low CTE due to the rigid structure of the 4-BAAB residue, and thus the internal stress can be reduced. The specific polyamic acid includes the 4-BAAB residue at a content of 70 mol % or more with respect to the total amount of diamine residues, and thus in the polyimide obtained using the polyamic acid composition according to one or more embodiments, the internal stress can be reduced.

In 4-BAAB, a carbonyl group of an ester bond exhibits an electron-withdrawing property and thus formation of a CT complex can be suppressed, and therefore 4-BAAB is suitable as a monomer component of a polyimide excellent in transparency.

Meanwhile, commercially available products (raw material monomers) of 4-BAAB for synthesis of a polyamic acid usually contain an aminophenol and a methyl aminobenzoate as an impurity. Examples of the aminophenol include one or more selected from the group consisting of p-aminophenol, m-aminophenol, and o-aminophenol. Examples of the methyl aminobenzoate include one or more selected from the group consisting of methyl 2-aminobenzoate, methyl 3-aminobenzoate, and methyl 4-aminobenzoate.

Hereinafter, a raw material (usually, a powdered raw material) containing 4-BAAB for synthesis of a polyamic acid and containing an impurity may be described as a “4-BAAB composition”. The aminophenol and the methyl aminobenzoate in the polyamic acid composition according to one or more embodiments are, for example, residual components of the impurity in the 4-BAAB composition. As a result of studies by the present inventor, it has been found that when the 4-BAAB composition containing a large amount of impurity is dissolved in a polymerization solvent, the solution is colored yellow or brown to cause deterioration of the transparency of the polyimide film after polymerization.

The result of GC/MS analysis of the 4-BAAB composition containing a large amount of impurity shows that impurities considered to be the cause of the coloring include aminotoluene, an aminophenol (specifically, p-aminophenol or the like), 2,4,4-trimethyl-1,3-pentanediol-1-isobutyrate, a methyl aminobenzoate (specifically, methyl 4-aminobenzoate or the like), an ethyl aminobenzoate (specifically, ethyl 4-aminobenzoate or the like), 4-aminobenzohydrazide, a 4-(1H-benzimidazole-2-yl)aniline derivative (estimated molecular weight 209), p-aminobenzoic acid, a 4-aminophenol derivative (estimated molecular weight 213), a 4-amino-N-(2-ethoxyphenyl)benzamide derivative (estimated molecular weight 256), a 4-(dimethylamino)-N-(2-ethoxyphenyl)benzamide derivative (estimated molecular weight 256), a N-(4-{[2-(3-phenylpropanoyl)hydrazino]carbonyl}phenyl)propanamide derivative (estimated molecular weight 284), and analogs thereof.

As a result of intensive studies by the present inventor, it has been found that as the content of a monoamine as an impurity increases, the transparency of the resulting polyimide film deteriorates, and particularly, as the amount of the aminophenol and the methyl aminobenzoate in the 4-BAAB composition increases, the transparency of the resulting polyimide film significantly deteriorates.

In one or more embodiments, the content of the aminophenol in the polyamic acid composition is 30 ppm by mass or less, and the content of the methyl aminobenzoate in the polyamic acid composition is 0.10 ppm by mass or less, so that deterioration of the transparency of the resulting polyimide film is suppressed, and the original function of 4-BAAB (the function of improving the transparency by suppressing formation of a CT complex) is sufficiently exhibited. Thus, the polyimide obtained using the polyamic acid composition according to one or more embodiments is excellent in transparency.

If the content of the aminophenol in the polyamic acid composition is in the range of 1 ppm by mass or more and 30 ppm by mass or less, an extremely small amount of the aminophenol tends to function as an imidization accelerator. If the content of the methyl aminobenzoate in the polyamic acid composition is in the range of 0.01 ppm by mass or more and 0.10 ppm by mass or less, an extremely small amount of the methyl aminobenzoate tends to function as an imidization accelerator.

In one or more embodiments, in order to obtain a polyimide more excellent in transparency while the internal stress is further reduced, the content of the 4-BAAB residue may be 80 mol % or more, 90 mol % or more, or 95 mol % or more, or may be 100 mol % with respect to the total amount of diamine residues included in the specific polyamic acid.

In one or more embodiments, in order to obtain a polyimide more excellent in transparency, the content of the aminophenol in the polyamic acid composition may be 28 ppm by mass or less, or 25 ppm by mass or less. In one or more embodiments, in order to obtain a polyimide more excellent in transparency, the content of the methyl aminobenzoate in the polyamic acid composition may be 0.08 ppm by mass or less, or 0.05 ppm by mass or less.

Both the content of the aminophenol in the polyamic acid composition and the content of the methyl aminobenzoate in the polyamic acid composition can be adjusted by changing the preparation condition of the 4-BAAB composition. Specifically, the contents can be adjusted by changing at least one of a method of purifying a raw material (4-nitrophenyl-4-nitrobenzoate) of 4-BAAB (specifically, a recrystallization method, an activated carbon treatment method, or the like) or a method of purifying the resulting 4-BAAB composition (specifically, an activated carbon treatment method, a recrystallization method, or the like). In the case of adopting a plurality of purification methods, the contents can also be adjusted by changing the order of carrying out the purification methods. An activated carbon treatment method is effective for reducing the aminophenol. Meanwhile, a recrystallization method is effective for reducing the methyl aminobenzoate.

In one or more embodiments, in order to obtain a polyimide more excellent in transparency, the Gardner color measured as follows may be 0.3 or less, or 0.2 or less. The Gardner color is measured with a cell having an optical path length of 1 cm using a sample obtained by diluting the polyamic acid composition so that the concentration of the specific polyamic acid is 1 mass %. In one or more embodiments, in order to obtain a polyimide more excellent in transparency, the Hazen color measured as follows may be 10 or less, or 8 or less. The Hazen color is measured with a cell having an optical path length of 1 cm using a sample obtained by diluting the polyamic acid composition so that the concentration of the specific polyamic acid is 1 mass %.

Hereinafter, the Hazen color may be described as “APAH”. The Gardner color measured as follows may be simply described as the “Gardner color of the polyamic acid composition”. The Gardner color is measured with a cell having an optical path length of 1 cm using a sample obtained by diluting the polyamic acid composition so that the concentration of the polyamic acid is 1 mass %. The APAH measured as follows may be simply described as the “APAH of the polyamic acid composition”. The APAH is measured with a cell having an optical path length of 1 cm using a sample obtained by diluting the polyamic acid composition so that the concentration of the polyamic acid is 1 mass %. Examples of the diluent solvent for preparation of the sample (specifically, the sample used in determination of the Gardner color of the polyamic acid composition and the APAH of the polyamic acid composition) include the same kind of organic solvent as the organic solvent contained in the polyamic acid composition.

The method of measuring the Gardner color of the polyamic acid composition and the method of measuring the APAH of the polyamic acid composition are the same as or similar to the methods in Examples described below. As the content of the aminophenol in the polyamic acid composition and the content of the methyl aminobenzoate in the polyamic acid composition are reduced, the Gardner color of the polyamic acid composition and the APAH of the polyamic acid composition tend to be reduced. The lower limit of the Gardner color of the polyamic acid composition and the lower limit of the APAH of the polyamic acid composition are not limited, and may be 0.

The specific polyamic acid contained in the polyamic acid composition according to one or more embodiments includes a tetracarboxylic dianhydride residue and a diamine residue.

Examples of the acid dianhydride (monomer) usable in synthesis of the specific polyamic acid include pyromellitic dianhydride, 3,3′,4,4′-biphenyltetracarboxylic dianhydride (hereinafter, sometimes described as “s-BPDA”), 2,3,3′,4′-biphenyltetracarboxylic dianhydride (hereinafter, sometimes described as “a-BPDA”), 2,2′,3,3′-biphenyltetracarboxylic dianhydride (hereinafter, sometimes described as “i-BPDA”), p-phenylenebis(trimellitate anhydride), 2,3,6,7-naphthalenetetracarboxylic dianhydride, 1,2,5,6-naphthalenetetracarboxylic dianhydride, 3,3′,4,4′-benzophenonetetracarboxylic dianhydride, 4,4′-oxydiphthalic anhydride (hereinafter, sometimes described as “ODPA”), 3,4′-oxydiphthalic anhydride (hereinafter, sometimes described as “a-ODPA”), spiro[11H-difuro[3,4-b:3′,4′-i]xanthene-11,9′-[9H]fluorene]-1,3,7,9-tetrone (hereinafter, sometimes described as “SFDA”), 9,9-bis(3,4-dicarboxyphenyl)fluorene dianhydride (hereinafter, sometimes described as “BPAF”), dicyclohexyl-3,3′,4,4′-tetracarboxylic dianhydride, 1,2,4,5-cyclohexanetetracarboxylic dianhydride, 1,2,3,4-cyclobutanetetracarboxylic dianhydride, 2′-oxodispiro[bicyclo[2.2.1]heptane-2,1′-cyclopentane-3′,2″-bicyclo[2.2.1]heptane]-5,6:5″,6″-tetracarboxylic dianhydride, 5,5′-bis-2-norbornene-5,5′,6,6′-tetracarboxylic acid-5,5′,6,6′-dianhydride (hereinafter, sometimes described as “BNBDA”), decahydro-1H,3H-4,10:5,9-dimethanonaphtho[2,3-c:6,7-c′]difuran-1,3,6,8-tetraone (hereinafter, sometimes described as “DNDA”), norbornane-2-spiro-α-cyclopentanone-α′-spiro-2″-norbornane-5,5″,6,6″-tetracarboxylic dianhydride (hereinafter, sometimes described as “CpODA”), and derivatives thereof, and these may be used singly or in combination of two or more kinds thereof.

In order to obtain a polyimide more excellent in transparency while the internal stress is further reduced, the specific polyamic acid may include one or more tetracarboxylic dianhydride residues selected from the group consisting of an s-BPDAresidue, an a-BPDAresidue, an i-BPDAresidue, an ODPAresidue, an a-ODPAresidue, an SFDAresidue, aBPAF residue, aDNDAresidue, afBNBDAresidue, and a CpODA residue, or may include one or more tetracarboxylic dianhydride residues selected from the group consisting of an s-BPDA residue, an a-BPDA residue, an SFDA residue, a BPAF residue, and an ODPA residue.

The s-BPDA residue is a tetravalent organic group represented by Chemical Formula (1) described below. The a-BPDA residue is a tetravalent organic group represented by Chemical Formula (2) described below. The i-BPDA residue is a tetravalent organic group represented by Chemical Formula (3) described below. The ODPA residue is a tetravalent organic group represented by Chemical Formula (4) described below. The a-ODPA residue is a tetravalent organic group represented by Chemical Formula (5) described below. The SFDA residue is a tetravalent organic group represented by Chemical Formula (6) described below. The BPAF residue is a tetravalent organic group represented by Chemical Formula (7) described below. The DNDA residue is a tetravalent organic group represented by Chemical Formula (8) described below. The BNBDA residue is a tetravalent organic group represented by Chemical Formula (9) described below. The CpODA residue is a tetravalent organic group represented by Chemical Formula (10) described below.

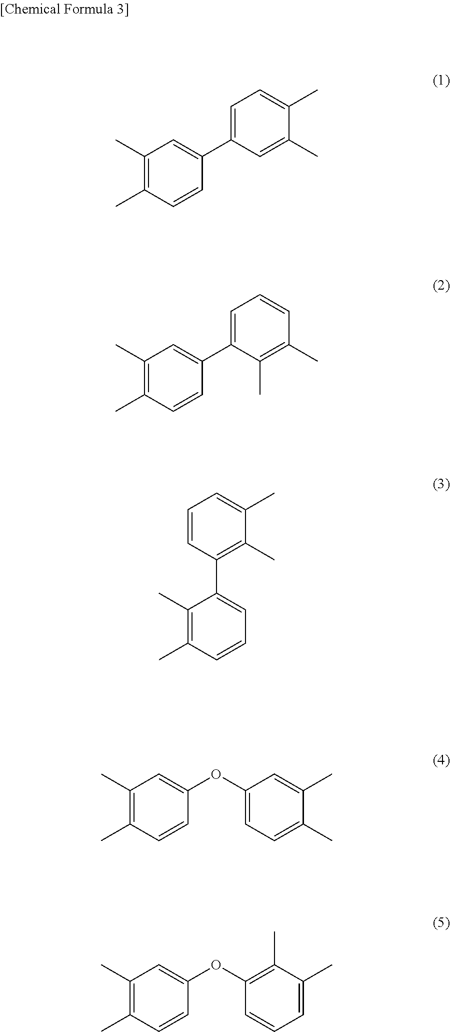

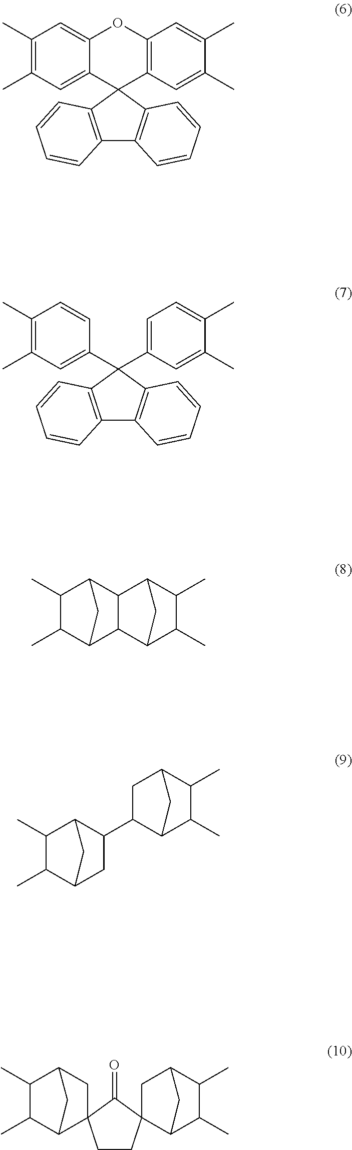

In order to obtain a polyimide in which the internal stress can be further reduced, the specific polyamic acid may include an s-BPDA residue as a tetracarboxylic dianhydride residue. In order to obtain a polyimide in which the internal stress can be still further reduced, the content of the s-BPDA residue may be 50 mol % or more, 60 mol % or more, or 70 mol % or more, or may be 100 mol % with respect to the total amount (100 mol %) of tetracarboxylic dianhydride residues included in the specific polyamic acid.

In order to obtain a polyimide more excellent in transparency, the specific polyamic acid includes one or more tetracarboxylic dianhydride residues selected from the group consisting of an a-BPDA residue, an SFDA residue, a BPAF residue, and an ODPA residue. In order to obtain a polyimide still more excellent in transparency, the content of one or more residues selected from the group consisting of an a-BPDA residue, an SFDA residue, a BPAF residue, and an ODPA residue may be 1 mol % or more and 50 mol % or less, 5 mol % or more and 40 mol % or less, or 10 mol % or more and 30 mol % or less, with respect to the total amount (100 mol %) of tetracarboxylic dianhydride residues included in the specific polyamic acid.

In order to obtain a polyimide still more excellent in transparency while the internal stress is still further reduced, the content of one or more residues selected from the group consisting of an s-BPDA residue, an a-BPDAresidue, an SFDA residue, a BPAF residue, and an ODPA residue may be 60 mol % or more, 70 mol % or more, 80 mol % or more, or 90 mol % or more, or may be 100 mol %, with respect to the total amount (100 mol %) of tetracarboxylic dianhydride residues included in the specific polyamic acid.

In synthesis of the specific polyamic acid, a diamine monomer other than 4-BAAB can also be used. Examples of the diamine (monomer) usable other than 4-BAAB include p-phenylenediamine, 1,3-bis(3-aminopropyl)tetramethyldisiloxane (hereinafter, sometimes described as “PAM-E”), 9,9-bis(4-aminophenyl)fluorene, 2,2′-bis(trifluoromethyl)-4,4′-diaminodiphenyl ether, 4,4′-diaminodiphenyl sulfone, 4,4′-diaminobenzanilide, m-phenylenediamine, 4,4′-oxydianiline, 3,4′-oxydianiline, N,N-bis(4-aminophenyl)terephthalamide, m-tolidine, o-tolidine, 4,4′-bis(4-aminophenoxy)biphenyl, 2-(4-aminophenyl)-6-aminobenzoxazole, 3,5-diaminobenzoic acid, 4,4′-diamino-3,3′-dihydroxybiphenyl, 4,4′-methylenebis(cyclohexanamine), and derivatives thereof, and these may be used singly or in combination of two or more kinds thereof.

In order to enhance the adhesion between the resulting polyimide film and a substrate, PAM-E may be used as the diamine (monomer). In order to further enhance the adhesion between the resulting polyimide film and a substrate, the content of the PAM-E residue may be 0.01 mol % or more and 1 mol % or less with respect to the total amount (100 mol %) of diamine residues included in the specific polyamic acid.

In order to enhance the adhesion between the polyimide film and a substrate in a high-temperature process by suppressing generation of hydrogen fluoride in a high-temperature atmosphere, the content of fluorine atoms in the specific polyamic acid may be less than 5 mass %, less than 1 mass %, or less than 0.5 mass % with respect to the total amount (100 mass %) of the specific polyamic acid.

The weight average molecular weight of the specific polyamic acid may be in the range of 10,000 or more and 1,000,000 or less, in the range of 20,000 or more and 500,000 or less, or in the range of 30,000 or more and 200,000 or less although depending on the use of the specific polyamic acid. If the weight average molecular weight is 10,000 or more, the viscosity of the polyamic acid composition can be easily adjusted to a range suitable for application (for example, 0.5 Pa s or more and 10 Pa s or less). Meanwhile, if the weight average molecular weight is 1,000,000 or less, the specific polyamic acid exhibits sufficient solubility in a solvent, and therefore a coating film or a polyimide film having a smooth surface and a uniform thickness can be obtained using the polyamic acid composition. The weight average molecular weight used herein refers to a value in terms of polyethylene oxide measured using gel permeation chromatography (GPC).

The polyamic acid composition according to one or more embodiments may contain an imidization accelerator and/or a dehydration catalyst in order to shorten the heating time and exhibit a property.

The imidization accelerator is not particularly limited, and a tertiary amine can be used. The tertiary amine may be a heterocyclic tertiary amine. Specific examples of the heterocyclic tertiary amine may include pyridine, picoline, quinoline, isoquinoline, and imidazole. Specific examples of the dehydration catalyst may include acetic anhydride, propionic anhydride, n-butyric anhydride, benzoic anhydride, and trifluoroacetic anhydride.

From the viewpoint of shortening the heating time and the viewpoint of exhibiting a property, the amount of the imidization accelerator may be 0.1 parts by mass or more and 20 parts by mass or less, or 0.5 parts by mass or more and 20 parts by mass or less with respect to 100 parts by mass of the specific polyamic acid. From the viewpoint of shortening the heating time and the viewpoint of exhibiting a property, the amount of the dehydration catalyst may be 0.1 parts by mass or more and 10 parts by mass or less, or 0.5 parts by mass or more and 5 parts by mass or less with respect to 100 parts by mass of the specific polyamic acid.

The imidization accelerator may be an imidazole. In the present description, an imidazole refers to a compound having a 1,3-diazole ring (1,3-diazole ring structure). The imidazole that can be added to the polyamic acid composition according to one or more embodiments is not particularly limited, and examples of the imidazole include 1H-imidazole, 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, and 1-benzyl-2-phenylimidazole. Among them, 1,2-dimethylimidazole, 1-benzyl-2-methylimidazole, and 1-benzyl-2-phenylimidazole are preferable, and 1,2-dimethylimidazole and 1-benzyl-2-methylimidazole are more preferable.

The content of the imidazole may be 0.005 mol or more and 0.1 mol or less, 0.01 mol or more and 0.08 mol or less, or 0.015 mol or more and 0.050 mol or less with respect to 1 mol of the amide group of the specific polyamic acid. Setting the content of the imidazole to 0.005 mol or more can improve the film strength and the transparency of the polyimide, and setting the content of the imidazole to 0.1 mol or less can improve the heat resistance while maintaining the storage stability of the specific polyamic acid. In the present description, the term “amide group of the specific polyamic acid” refers to an amide group generated by a polymerization reaction between a diamine and a tetracarboxylic dianhydride.

The method of mixing the specific polyamic acid and the imidazole is not particularly limited. From the viewpoint of ease of controlling the molecular weight of the specific polyamic acid, the imidazole may be added to the specific polyamic acid after polymerization. At this time, the imidazole may be added to the specific polyamic acid as it is, or a solution obtained by dissolving the imidazole in a solvent in advance may be added to the specific polyamic acid, and thus the addition method is not particularly limited. The imidazole may be added to a solution containing the specific polyamic acid after polymerization (solution after the reaction) to prepare the polyamic acid composition according to one or more embodiments.

In the polyamic acid composition according to one or more embodiments, various organic or inorganic low molecular weight compounds or polymer compounds may be blended as additives. Examples of a usable additive include a plasticizer, an antioxidant, a dye, a surfactant, a leveling agent, silicone, fine particles, and a sensitizer. The fine particles include organic fine particles including polystyrene and polytetrafluoroethylene, and inorganic fine particles including colloidal silica, carbon, and layered silicate, and may have a porous structure or a hollow structure. The function and the form of the fine particles are not particularly limited, and the fine particles may be, for example, a pigment, a filler, or fibrous particles.

The polyamic acid composition according to one or more embodiments can contain a silane coupling agent in order to develop appropriate adhesion to a support. As the silane coupling agent, a known silane coupling agent can be used without particular limitation. For development of good adhesion to a support, the usable silane coupling agent may be a compound including an amino group, one or more compounds selected from the group consisting of 3-aminopropyltrimethoxysilane, 3-aminopropyltriethoxysilane, 3-aminopropyldiethoxymethylsilane, 3-(ethoxydimethylsilyl)propylamine, N-2-(aminoethyl)-3-aminopropyltrimethoxysilane, N-2-(aminoethyl)-3-aminopropylmethyldimethoxysilane, and N-phenyl-3-aminopropyltrimethoxysilane, one or more compounds selected from the group consisting of 3-aminopropyltriethoxysilane and 3-aminopropyldiethoxymethylsilane, or 3-aminopropyltriethoxysilane.

The ratio of the silane coupling agent blended to 100 parts by mass of the specific polyamic acid may be 0.01 parts by mass or more and 0.50 parts by mass or less, 0.01 parts by mass or more and 0.30 parts by mass or less, or 0.01 parts by mass or more and 0.20 parts by mass or less. If the ratio of the silane coupling agent blended is 0.01 parts by mass or more, the effect of suppressing peeling from a support is sufficiently exhibited, and if the ratio of the silane coupling agent blended is 0.50 parts by mass or less, a decrease in the molecular weight of the specific polyamic acid is suppressed, so that embrittlement of the polyimide film can be suppressed.

In order to obtain a polyimide still more excellent in transparency while the internal stress is still further reduced, the polyamic acid composition according to one or more embodiments may satisfy the following condition 1, may satisfy the following condition 2, or may satisfy the following condition 3.
Condition 1: The specific polyamic acid includes one or more residues selected from the group consisting of an s-BPDA residue, an a-BPDA residue, an SFDA residue, a BPAF residue, and an ODPA residue, and the content of the one or more residues selected from the group consisting of an s-BPDA residue, an a-BPDA residue, an SFDA residue, a BPAF residue, and an ODPA residue is 80 mol % or more and 100 mol % or less with respect to the total amount (100 mol %) of tetracarboxylic dianhydride residues included in the specific polyamic acid.
Condition 2: The condition 1 is satisfied, and the content of the 4-BAAB residue is 80 mol % or more and 100 mol % or less with respect to the total amount (100 mol %) of diamine residues included in the specific polyamic acid.
Condition 3: The condition 2 is satisfied, and the Gardner color of the polyamic acid composition and the APAH of the polyamic acid composition are 0.3 or less and 10 or less, respectively.

A method of producing the polyamic acid composition according to one or more embodiments includes a step S1 of reacting a diamine with a tetracarboxylic dianhydride in an organic solvent. As the method of reacting a diamine with a tetracarboxylic dianhydride in an organic solvent, a known general method can be adopted as long as the following conditions A to F are satisfied. A specific method of reacting a diamine with a tetracarboxylic dianhydride in an organic solvent will be described below.
Condition A: At least 4-BAAB is used as the diamine (monomer).
Condition B: The content of 4-BAAB in the diamine (monomer) is 70 mol % or more with respect to the total amount (100 mol %) of the diamine.
Condition C: 4-BAAB is subjected to the step S1 as a raw material containing an impurity (4-BAAB composition).
Condition D: The impurity in the 4-BAAB composition contains aminophenol and methyl aminobenzoate.
Condition E: The Gardner color measured with a cell having an optical path length of 1 cm using a 1 mass % NMP solution of the 4-BAAB composition is 3.0 or less.
Condition F: The APAH measured with a cell having an optical path length of 1 cm using a 1 mass % NMP solution of the 4-BAAB composition is 200 or less.

If the above-described conditions A to F are satisfied, the polyamic acid composition according to one or more embodiments described above can be easily produced.

Hereinafter, the Gardner color measured with a cell having an optical path length of 1 cm using a 1 mass % NMP solution of the 4-BAAB composition may be simply described as “Gardner color of the 4-BAAB composition”. The APAH measured with a cell having an optical path length of 1 cm using a 1 mass % NMP solution of the 4-BAAB composition may be simply described as “APAH of the 4-BAAB composition”. The method of measuring the Gardner color of the 4-BAAB composition and the method of measuring the APAH of the 4-BAAB composition are the same as or similar to the methods in Examples described below. As the content of the aminophenol in the 4-BAAB composition and the content of the methyl aminobenzoate in the 4-BAAB composition are reduced, the Gardner color of the 4-BAAB composition and the APAH of the 4-BAAB composition tend to be reduced. The lower limit of the Gardner color of the 4-BAAB composition and the lower limit of the APAH of the 4-BAAB composition are not limited, and may be 0.

In order to obtain a polyimide more excellent in transparency while the internal stress is further reduced, the method of producing the polyamic acid composition according to one or more embodiments may satisfy the following conditions G and H.
Condition G: The content of the aminophenol in the 4-BAAB composition is 0.60 mass % or less with respect to the total amount (100 mass %) of 4-BAAB.
Condition H: The content of the methyl aminobenzoate in the 4-BAAB composition is 0.60 mass % or less with respect to the total amount (100 mass %) of 4-BAAB.

Hereinafter, the content of the aminophenol in the 4-BAAB composition with respect to the total amount of 4-BAAB may be simply described as “the content of the aminophenol in the 4-BAAB composition”. The content of the methyl aminobenzoate in the 4-BAAB composition with respect to the total amount of 4-BAAB may be simply described as “the content of the methyl aminobenzoate in the 4-BAAB composition”. The method of measuring “the content of the aminophenol in the 4-BAAB composition” and the method of measuring “the content of the methyl aminobenzoate in the 4-BAAB composition” are the same as or similar to the methods in Examples described below.

In order to obtain a polyimide still more excellent in transparency while the internal stress is still further reduced, the content of the aminophenol in the 4-BAAB composition may be 0.05 mass % or more and 0.60 mass % or less, 0.10 mass % or more and 0.58 mass % or less, or 0.15 mass % or more and 0.56 mass % or less.

In order to obtain a polyimide still more excellent in transparency while the internal stress is still further reduced, the content of the methyl aminobenzoate in the 4-BAAB composition may be 0.01 mass % or more and 0.60 mass % or less, 0.02 mass % or more and 0.40 mass % or less, or 0.03 mass % or more and 0.20 mass % or less.

In order to obtain a polyimide still more excellent in transparency while the internal stress is still further reduced, the content of ethyl aminobenzoate in the 4-BAAB composition may be 0.15 mass % or less, 0.01 mass % or more and 0.15 mass % or less, 0.02 mass % or more and 0.10 mass % or less, or 0.02 mass % or more and 0.05 mass % or less with respect to the total amount (100 mass %) of 4-BAAB.

An example of the method (synthesis method) of reacting a diamine with a tetracarboxylic dianhydride in an organic solvent will be described. First, in a first method, a diamine is dissolved or dispersed in a slurry form in an organic solvent in an atmosphere of an inert gas such as argon or nitrogen to prepare a diamine solution. In the method, then a tetracarboxylic dianhydride in a state of being dissolved or dispersed in a slurry form in an organic solvent, or a tetracarboxylic dianhydride in a solid state is added to the diamine solution. In a second method, a tetracarboxylic dianhydride is dissolved or dispersed in a slurry form in an organic solvent in an atmosphere of an inert gas such as argon or nitrogen to prepare a tetracarboxylic dianhydride solution. In the method, then a diamine in a state of being dissolved or dispersed in a slurry form in an organic solvent, or a diamine in a solid state is added to the tetracarboxylic dianhydride solution.

In the case of synthesizing the specific polyamic acid using a diamine and a tetracarboxylic dianhydride, the desired specific polyamic acid (polymer of the diamine and the tetracarboxylic dianhydride) can be obtained by adjusting the substance amount of the diamine (substance amount of each diamine in the case of using a plurality of diamines) and the substance amount of the tetracarboxylic dianhydride (substance amount of each tetracarboxylic dianhydride in the case of using a plurality of tetracarboxylic dianhydrides). The molar fraction of each residue in the specific polyamic acid is equal to, for example, the molar fraction of each monomer (each monomer corresponding to each residue) used for synthesis of the specific polyamic acid. A specific polyamic acid containing a plurality of tetracarboxylic dianhydride residues and a plurality of diamine residues can also be obtained by blending two polyamic acids. The temperature condition for the reaction of the diamine and the tetracarboxylic dianhydride, that is, the synthesis reaction of the specific polyamic acid is not particularly limited, and is, for example, in the range of 20° C. or higher and 150° C. or lower. The reaction time for the synthesis reaction of the specific polyamic acid is, for example, in the range of 10 minutes or more and 30 hours or less.

Examples of a method of controlling the molecular weight of the specific polyamic acid include a method in which an acid dianhydride or a diamine is excessively used, and a method in which a monofunctional acid anhydride or a monofunctional amine, such as phthalic anhydride or aniline, is reacted to quench the reaction. In a case where an acid dianhydride or a diamine is excessively used for polymerization, a polyimide film having sufficient strength can be obtained as long as the molar ratio of the diamine to the acid dianhydride for preparation is in the range from 0.95 to 1.05. The above-described molar ratio of the diamine to the acid dianhydride for preparation is the ratio of the total substance amount of the diamine used for synthesis of the specific polyamic acid to the total substance amount of the acid dianhydride used for synthesis of the specific polyamic acid (total substance amount of diamine/total substance amount of acid dianhydride). It is also possible to use phthalic anhydride, maleic anhydride, aniline, or the like for end-capping to further reduce coloring of the polyimide obtained using the specific polyamic acid.

The organic solvent used for synthesis of the specific polyamic acid may be a solvent capable of dissolving the tetracarboxylic dianhydride and the diamine to be used, or a solvent capable of dissolving the specific polyamic acid to be generated. Examples of the organic solvent used for synthesis of the specific polyamic acid include urea-based solvents such as N,N-dimethylethylurea; sulfoxide-based solvents such as dimethyl sulfoxide, sulfone-based solvents such as tetramethyl sulfone; amide-based solvents such as N,N-dimethylacetamide (DMAC), N,N-dimethylformamide (DMF), N,N-diethylformamide, N,N-diethylacetamide, N-methyl-2-pyrrolidone (NMP), N-butyl-2-pyrrolidone, 3-methoxy-N,N-dimethylpropanamide (MPA), and hexamethylphosphoric triamide; ester-based solvents such as γ-butyrolactone; alkyl halide-based solvents such as chloroform; aromatic hydrocarbon-based solvents such as toluene; phenol-based solvents such as phenol; ketone-based solvents such as cyclopentanone; and ether-based solvents such as tetrahydrofuran. These solvents are usually used singly, and may be appropriately used in combination of two or more kinds thereof as necessary. The organic solvent used for synthesis of the specific polyamic acid may be one or more solvents selected from the group consisting of amide-based solvents, ketone-based solvents, ester-based solvents, and ether-based solvents, or an amide-based solvent (more specifically, DMF, DMAC, NMP, MPA, or the like). The synthesis reaction of the specific polyamic acid may be performed under an atmosphere of an inert gas such as argon or nitrogen.

In the case of obtaining the specific polyamic acid with the above-described method, the reaction solution (solution after the reaction) itself may be used as the polyamic acid composition according to one or more embodiments. In this case, the organic solvent in the polyamic acid composition is the organic solvent used in the synthesis reaction. Alternatively, the solid specific polyamic acid obtained by removing the solvent from the reaction solution may be dissolved in an organic solvent to prepare the polyamic acid composition according to one or more embodiments.

The concentration of the specific polyamic acid in the polyamic acid composition according to one or more embodiments is not particularly limited, and may be, for example, 5 mass % or more and 40 mass % or less, or 8 mass % or more and 30 mass % or less with respect to the total amount (100 mass %) of the polyamic acid composition.

The polyimide according to one or more embodiments is an imidized product of the above-described specific polyamic acid. The polyimide according to one or more embodiments can be obtained with a known method, and the method of producing the polyimide is not particularly limited. Hereinafter, an example of the method will be described in which the specific polyamic acid is imidized to obtain the polyimide according to one or more embodiments. The imidization is performed by subjecting the specific polyamic acid to cyclodehydration. The cyclodehydration can be performed with an azeotropic method using an azeotropic solvent, a thermal method, or a chemical method. The imidization from the specific polyamic acid to the polyimide can be performed at any percentage of 1% or more and 100% or less. That is, the specific polyamic acid that is partially imidized may be synthesized. In particular in the case of imidization by heating, the ring closure reaction from the specific polyamic acid to the polyimide and the hydrolysis of the specific polyamic acid proceed at the same time, and the resulting polyimide may have a lower molecular weight than the specific polyamic acid. Therefore, the specific polyamic acid in the polyamic acid composition may be partially imidized in advance before forming a polyimide film described below from the viewpoint of improving a mechanical property. In the present description, the partially imidized polyamic acid may also be described as “polyamic acid”.

The cyclodehydration of the specific polyamic acid is to be performed by heating the specific polyamic acid. The method of heating the specific polyamic acid is not particularly limited, and for example, a method may be used in which the polyamic acid composition according to one or more embodiments described above is applied onto a support such as a glass substrate, a metal plate, or a polyethylene terephthalate film (PET film) and then the specific polyamic acid is heat-treated at a temperature in the range of 40° C. or higher and 500° C. or lower. This method provides a laminate according to one or more embodiments including a support and a polyimide film (specifically, a polyimide film containing the imidized product of the specific polyamic acid) disposed on the support. Alternatively, cyclodehydration of the specific polyamic acid can be performed by directly putting the polyamic acid composition into a container subjected to a release treatment such as coating with a fluorine-based resin, and heating and drying the polyamic acid composition under reduced pressure. The polyimide can be obtained by cyclodehydration of the specific polyamic acid with these methods. The heating time in each treatment described above depends on the amount of the polyamic acid composition subjected to cyclodehydration and the heating temperature, but the heating time may be generally in the range of 1 minute or more and 300 minutes or less after the treatment temperature reaches the maximum temperature.

The polyimide film (specifically, polyimide film containing the imidized product of the specific polyamic acid) according to one or more embodiments is colorless and transparent and has a low yellowness index and a glass transition temperature (heat resistance) to be resistant to a step of preparing a TFT, and therefore is suitable for a transparent substrate material of a flexible display. The content of the polyimide (specifically, imidized product of the specific polyamic acid) in the polyimide film according to one or more embodiments may be, for example, 70 mass % or more, 80 mass % or more, or 90 mass % or more, and may be 100 mass %, with respect to the total amount of the polyimide film. Examples of the component other than the polyimide in the polyimide film include the above-described additives (more specifically, fine particles and the like).

An electronic device (more specifically, flexible device or the like) according to one or more embodiments includes the polyimide film according to one or more embodiments and an electronic element directly or indirectly disposed on the polyimide film. In the case of producing the electronic device according to one or more embodiments for a flexible display, first, a polyimide film is formed on an inorganic substrate, such as glass, serving as a support. Then, an electronic element such as a TFT is disposed (formed) on the polyimide film to form an electronic device on the support. The step of forming a TFT is generally performed in a wide temperature range of 150° C. or higher and 650° C. or lower, and in order to actually achieve desired performance, an oxide semiconductor layer or an a-Si layer is formed at 300° C. or higher, and in some cases, a-Si or the like is further crystallized with a laser or the like.

At this time, if the polyimide film has a low thermal decomposition temperature, outgassing occurs during formation of an electronic element, and a sublimate may adhere to the inside of the oven to cause contamination in the furnace, or an inorganic film (a barrier film or the like described below) formed on the polyimide film or the electronic element may be peeled off. Therefore, the polyimide may have a 1% weight loss temperature of 500° C. or higher. The upper limit of the 1% weight loss temperature of the polyimide may be as high as possible, or may be, for example, 600° C. The 1% weight loss temperature can be adjusted, for example, by changing the content of a residue having a rigid structure (more specifically, for example, an s-BPDA residue). More specifically, before forming a TFT, an inorganic film such as a silicon oxide film (SiOx film) or a silicon nitride film (SiNx film) is formed as a barrier film on the polyimide film. At this time, if the polyimide has low heat resistance, or progress of imidization is incomplete, or the amount of the residual solvent is large, a volatile component such as a decomposition gas of the polyimide may cause peeling of the inorganic film from the polyimide in a high-temperature process after layering the inorganic film. Therefore, it is desirable that the inorganic film is not peeled from the polyimide film when the laminate after formation of the inorganic film is held at a temperature of 400° C. for 1 hour. A TFT has higher performance as the treatment temperature is higher, and therefore it is desirable that the inorganic film is not peeled from the polyimide film when the laminate after formation of the inorganic film is held at a temperature of 430° C. for 1 hour, and it is more desirable that the inorganic film is not peeled from the polyimide film when the laminate after formation of the inorganic film is held at a temperature of 470° C. for 1 hour.

If the polyimide has a glass transition temperature (Tg) significantly lower than the process temperature, positional deviation or the like may occur during formation of an electronic element. Therefore, the polyimide may have a Tg of 400° C. or higher, 420° C. or higher, 430° C. or higher, or 450° C. or higher. The upper limit of the Tg of the polyimide may be as high as possible, or may be, for example, 500° C. Furthermore, an internal stress is generated between the glass substrate and the polyimide film because a glass substrate generally has a smaller thermal expansion coefficient than a resin. If the internal stress is high in the laminate including the glass substrate used as a support, the electronic element, and the polyimide film, after the laminate including the polyimide film expands in the high-temperature TFT forming step, the laminate contracts when cooled to normal temperature to may cause warpage and breakage of the glass substrate and peeling of the polyimide film from the glass substrate. Therefore, in the laminate (laminate according to one or more embodiments) including the glass substrate (support) and the polyimide film, the internal stress between the polyimide film and the glass substrate may be 30 MPa or less, 20 MPa or less, or 10 MPa or less. The lower limit of the internal stress may be as low as possible, or may be 0 MPa. The method of measuring the internal stress is the same as or similar to the method in Examples described below.

The polyimide according to one or more embodiments can be suitably used as a material of a display substrate such as a TFT substrate or a touch panel substrate. In the above-described use of the polyimide, a method is often adopted in which an electronic device (specifically, electronic device in which an electronic element is formed on a polyimide film) is formed on a support as described above and then the polyimide film is peeled from the support. As a material of the support, alkali-free glass is suitably used. Hereinafter, an example of a method of producing a laminate including a polyimide film and a support will be described in detail.

First, the polyamic acid composition according to one or more embodiments is applied (cast) onto a support to form a coating film-containing laminate that includes a coating film containing the specific polyamic acid and includes the support. Next, the coating film-containing laminate is heated under a condition of, for example, a temperature of 40° C. or higher and 200° C. or lower. The heating time at this time is, for example, 3 minutes or more and 120 minutes or less. Amulti-stage heating step may be provided such that the coating film-containing laminate is heated at a temperature of 50° C. for 30 minutes and then heated at a temperature of 100° C. for 30 minutes. Next, in order to advance imidization of the specific polyamic acid in the coating film, the coating film-containing laminate is heated under a condition of, for example, a maximum temperature of 200° C. or higher and 500° C. or lower. The heating time (heating time at the maximum temperature) at this time is, for example, 1 minute or more and 300 minutes or less. At this time, the temperature may be raised gradually from a low temperature to the maximum temperature. The temperature rise rate may be 2° C./min or more and 10° C./min or less, or 4° C./min or more and 10° C./min or less. The maximum temperature may be in the range of 250° C. or higher and 450° C. or lower. If the maximum temperature is 250° C. or higher, imidization sufficiently proceeds, and if the maximum temperature is 450° C. or lower, thermal deterioration and coloring of the polyimide can be suppressed. The temperature may be held at any temperature for any period of time until reaching the maximum temperature. The imidization reaction can be performed under air, under reduced pressure, or in an inert gas such as nitrogen, and in order to develop higher transparency, the imidization reaction may be performed under reduced pressure or in an inert gas such as nitrogen. As a heater, a known device such as a hot-air oven, an infrared oven, a vacuum oven, an inert oven, or a hot plate can be used. Through these steps, the specific polyamic acid in the coating film is imidized, and a laminate (that is, the laminate according to one or more embodiments) can be obtained that includes the support and the polyimide film (film containing an imidized product of the specific polyamic acid).

As a method of peeling the polyimide film from the obtained laminate including the support and the polyimide film, a known method can be used. For example, the polyimide film may be peeled manually, or may be peeled using a machine such as a drive roll or a robot. Furthermore, a method can be adopted in which a peeling layer is provided between a support and a polyimide film, and a method can be adopted in which a silicon oxide film is formed on a substrate having a large number of grooves, a polyimide film is formed using the silicon oxide film as a base layer, and an etching solution of silicon oxide is infiltrated between the substrate and the silicon oxide film to peel the polyimide film. In addition, a method can be adopted in which the polyimide film is separated by irradiation with laser light.

The transparency of the polyimide film can be evaluated, for example, with the total light transmittance (TT) in accordance with JIS K 7361-1: 1997 and the haze in accordance with JIS K 7136-2000. In a use of the polyimide film in which high transparency is required, the polyimide film may have a total light transmittance of 75% or more, or 80% or more. In a use of the polyimide film in which high transparency is required, the polyimide film may have a haze of 1.5% or less, 1.2% or less, or 1.0% or less, or the haze may be 0%. In a use in which high transparency is required, the polyimide film is required to have high transmittance in the entire wavelength region, but the polyimide film tends to absorb light on the short wavelength side, and the film itself is often colored yellow. For a use of the polyimide film in which high transparency is required, coloring of the polyimide film may be reduced. Specifically, for a use of the polyimide film in which high transparency is required, the polyimide film may have a yellowness index (YI) of 25 or less, or 20 or less, or the yellowness index may be 0. The YI can be measured in accordance with JIS K 7373-2006. The YI can be adjusted, for example, by changing the contents of the aminophenol and the methyl aminobenzoate in the polyamic acid composition. As described above, the polyimide film in which coloring is reduced and transparency is imparted is suitable for a transparent substrate for use as a substitute for glass, or a substrate having a back surface on which a sensor or a camera module is provided.

In use in which transparency is required, the transmittance of blue light (light having a wavelength of around 470 nm) is particularly required to be high from the viewpoint of color reproducibility and the like, and practically, the transmittance of light having a wavelength of 400 nm (400 nm transmittance) is required to be high. From the viewpoint of color reproducibility and the like, the polyimide film may have a 400 nm transmittance of 8% or more. The upper limit of the 400 nm transmittance of the polyimide film is not particularly limited, and may be 100%. The 400 nm transmittance can be adjusted, for example, by changing the contents of the aminophenol and the methyl aminobenzoate in the polyamic acid composition.

The light extraction systems of flexible displays are classified into two types: a top emission system that extracts light from the front surface side of a TFT; and a bottom emission system that extracts light from the back surface side of a TFT. The top emission system is characterized in that light is not blocked by the TFT and thus the aperture ratio can be easily increased to obtain high definition image quality, and the bottom emission system is characterized in that alignment between the TFT and the pixel electrode is easy and thus the production is facilitated. If the TFT is transparent, the aperture ratio can be improved even in the bottom emission system, and therefore a large display tends to adopt a bottom emission system, which is easy to produce. The polyimide film according to one or more embodiments has a low YI and excellent heat resistance, and therefore can be applied to both of the light extraction systems described above.

In a batch-type device preparation process in which the polyamic acid composition is applied onto a support such as a glass substrate and imidized by heating, an electronic element or the like is formed, and then the polyimide film is peeled off, the adhesion between the support and the polyimide film may be excellent. The term “adhesion” as used herein means adhesive strength. In a preparation process in which an electronic element or the like is formed on a polyimide film on a support and then the polyimide film on which the electronic element or the like is formed is peeled from the support, if the adhesion between the polyimide film and the support is excellent, the electronic element or the like can be formed or mounted more accurately. Ina production process in which an electronic element or the like is disposed on a support via a polyimide film, the peel strength between the support and the polyimide film may be as high as possible from the viewpoint of improving the productivity. Specifically, the peel strength may be 0.05 N/cm or more, or 0.1 N/cm or more.

In a production process as described above, when the polyimide film is peeled from the laminate including the support and the polyimide film, laser irradiation is often used for peeling the polyimide film from the support. In this case, the polyimide film needs to absorb the laser light, and therefore the polyimide film is required to have a cut-off wavelength longer than the wavelength of the laser light used for peeling. For laser peeling, a XeC1 excimer laser with a wavelength of 308 nm is often used, and therefore the polyimide film may have a cut-off wavelength of 312 nm or more, or 330 nm or more. Meanwhile, a polyimide film having a long cut-off wavelength tends to be colored yellow, and therefore the polyimide film may have a cut-off wavelength of 390 nm or less. From the viewpoint of achieving both the transparency (low yellowness) and the processability of laser peeling, the polyimide film may have a cut-off wavelength of 320 nm or more and 390 nm or less, or 330 nm or more and 390 nm or less. The cut-off wavelength in the present description means the wavelength at which the transmittance becomes 0.1% or less as measured by an ultraviolet-visible spectrophotometer.

The polyamic acid composition and the polyimide according to one or more embodiments may be used as they are in coating or a molding process for preparation of a product or a member, and can also be used as a material for a further treatment such as coating on a molded product molded into a film shape. For use in coating or a molding process, a composition containing the specific polyamic acid or the polyimide may be prepared by dissolving or dispersing the polyamic acid composition or the polyimide in an organic solvent as necessary, and further blending a photocurable component, a thermosetting component, a non-polymerizable binder resin, and another component as necessary.

On a surface of the polyimide film according to one or more embodiments, various inorganic thin films may be formed such as a metal oxide thin film and a transparent electrode. The methods of forming these inorganic thin films are not particularly limited, and examples thereof include PVD methods such as a sputtering method, a vacuum vapor deposition method, an ion plating method, and CVD methods.

In the polyimide film according to one or more embodiments, the internal stress generated at the time of forming a laminate with a glass substrate is so small that the adhesion to an inorganic material during a high-temperature process can be ensured in addition to the heat resistance, the low thermal expansion, and the transparency, and therefore the polyimide film may be used in fields and products where these properties are effective. For example, the polyimide film according to one or more embodiments may be used in an image display device such as a liquid crystal display device, an organic EL, or an electronic paper, a printed matter, a color filter, a flexible display, an optical film, a 3D display, a touch panel, a transparent conductive film substrate, a solar cell, or the like, and may be used as an alternative material for a portion where glass is currently used. In these uses, the polyimide film may have a thickness of, for example, 1 μm or more and 200 μm or less, or 5 μm or more and 100 μm or less. The thickness of the polyimide film can be measured by using a laser hologage.

The polyamic acid composition according to one or more embodiments can be suitably used in a method of producing a polyimide film, in which the polyamic acid composition is applied onto a support and imidized by heating and then the polyimide film is peeled from the support. Furthermore, the polyamic acid composition according to one or more embodiments can be suitably used in a batch-type device preparation process in which the polyamic acid composition is applied onto a support and imidized by heating, an electronic element or the like is formed on the formed polyimide film, and then the polyimide film on which the electronic element or the like is formed is peeled from the support. Therefore, one or more embodiments also include a method of producing an electronic device, including a step of applying the polyamic acid composition on a support, heating the polyamic acid composition to imidize the polyamic acid, and forming an electronic element or the like on a polyimide film formed on the support. The method of producing an electronic device may further include a step of peeling the polyimide film on which the electronic element or the like is formed from the support.

### EXAMPLES

Examples of one or more embodiments of the present invention will be described below, but the scope of the present invention is not limited to the following examples. In the following, compounds and reagents are represented by the following abbreviations.
NMP: N-methyl-2-pyrrolidone
s-BPDA: 3,3′,4,4′-Biphenyltetracarboxylic dianhydride
a-BPDA: 2,3,3′,4′-Biphenyltetracarboxylic dianhydride
SFDA: Spiro[11H-difuro[3,4-b:3′,4′-i]xanthene-11,9′-[9H]fluorene]-1,3,7,9-tetrone
BPAF: 9,9-Bis(3,4-dicarboxyphenyl)fluorene dianhydride
ODPA: 4,4′-Oxydiphthalic anhydride
4-BAAB: 4-Aminophenyl-4-aminobenzoate

### <Methods of Measuring Physical Properties>

First, methods of measuring physical properties of a 4-BAAB composition, a polyamic acid composition, and a polyimide (polyimide film) will be described.

### [Gardner Color]

First, the Gardner color of distilled water was measured with a cell having an optical path length of 1 cm in accordance with IS04630 using a colormeter for petroleum products (“OME-2000” manufactured by NIPPON DENSHOKU INDUSTRIES CO., LTD.) to confirm that the measured value was 0.0. Next, the Gardner color of each sample (1 mass % NMP solution of each 4-BAAB composition or each polyamic acid composition diluted with NMP to a polyamic acid concentration of 1 mass %) was measured with the same method as in the case of the distilled water. The Gardner color of the used NMP itself was measured with the same method as in the case of the distilled water to confirm that the Gardner color of the NMP was 0.0.

### [APAH]

First, the APAH of distilled water was measured with a cell having an optical path length of 1 cm in accordance with IS02211 using a colormeter for petroleum products (“OME-2000” manufactured by NIPPON DENSHOKU INDUSTRIES CO., LTD.) to confirm that the measured value was 0. Next, the APAH of each sample (1 mass % NMP solution of each 4-BAAB composition or each polyamic acid composition diluted with NMP to a polyamic acid concentration of 1 mass %) was measured with the same method as in the case of the distilled water. The APAH of the used NMP itself was measured with the same method as in the case of the distilled water to confirm that the APAH of the NMP was 0.

### [Internal Stress]

Each polyamic acid composition prepared in Examples and Comparative Examples described below was applied with a spin coater onto a glass substrate manufactured by Corning Incorporated (trade name: Eagle XG, material: alkali-free glass, thickness: 0.7 mm, size: 100 mm×100 mm) measured in advance to determine the amount of warpage, and the resulting product was heated at 120° C. for 30 minutes in the air, and then heated at 430° C. for 30 minutes in a nitrogen atmosphere to obtain a laminate including a polyimide film having a thickness of 10 μm on the glass substrate. In order to eliminate the influence of water absorption of the polyimide film, the laminate was dried at 120° C. for 10 minutes, and then the amount of warpage of the laminate was measured in a nitrogen atmosphere at a temperature of 25° C. using a thin film stress measuring device (“FLX-2320-S” manufactured by KLA-Tencor Corporation). Then, from the amount of warpage of the glass substrate before formation of the polyimide film and the amount of warpage of the laminate, the internal stress generated between the glass substrate and the polyimide film was calculated with the Stoney equation. A case where the internal stress was 30 MPa or less was evaluated as a case where “the internal stress can be reduced”. A case where the internal stress was more than 30 MPa was evaluated as a case where “the internal stress cannot be reduced”.

### [Yellowness Index (YI)]

For the polyimide film in each laminate obtained in Examples and Comparative Examples described below, the transmittance of light having a wavelength of 200 nm or more and 800 nm or less was measured using an ultraviolet visible near infrared spectrophotometer (“V-650” manufactured by JASCO Corporation), and the yellowness index (YI) of the polyimide film was calculated from the formula described in JIS K 7373-2006. A polyimide film having a YI of 20 or less was evaluated as “excellent in transparency”. A polyimide film having a YI of more than 20 was evaluated as “not excellent in transparency”.

### [400 nm Transmittance and 450 nm Transmittance]

For the polyimide film in each laminate obtained in Examples and Comparative Examples described below, the transmittance of light having a wavelength of 400 nm (400 nm transmittance) and the transmittance of light having a wavelength of 450 nm (450 nm transmittance) were measured using an ultraviolet visible near infrared spectrophotometer (“V-650” manufactured by JASCO Corporation).

### [GC/MS Analysis of 4-BAAB Composition]

Each sample (1 mass % NMP solution of each 4-BAAB composition) was subjected to GC/MS analysis under the following conditions using a GC/MS analyzer in which gas chromatography (“6890N” manufactured by Agilent Technologies) and a mass spectrometer (“5975 inert” manufactured by Agilent Technologies) were combined. The obtained GC/MS chart was used to calculate the area S1 of a peak having a retention time (RT) in the range of 11.405 to 11.603 minutes (peak derived from aminophenol), the area S₂ of a peak having an RT in the range of 13.196 to 13.256 minutes (peak derived from methyl aminobenzoate), the area S₃ of a peak having an RT in the range of 13.652 to 13.704 minutes (peak derived from ethyl aminobenzoate), and the area S₄ of a peak having an RT in the range of 18.303 to 18.803 minutes (peak derived from 4-BAAB). Then, the content (unit: mass %) of aminophenol in the 4-BAAB composition was calculated from the formula “100×S₁/S₄”, the content (unit: mass %) of methyl aminobenzoate in the 4-BAAB composition was calculated from the formula “100×S₂/S₄”, and the content (unit: mass %) of ethyl aminobenzoate in the 4-BAAB composition was calculated from the formula “100×S₃/S₄”.

### (Conditions for GC/MS Analysis)

Column: “DB-5MS” (0.25 mm ID×30 m, film thickness 0.25 μm) manufactured by Agilent Technologies
Carrier gas: Helium gas (1 mL/min)
Oven temperature: Set to 40° C., and raised to 320° C. at 20° C./min
Inlet temperature: 280° C.
Interface temperature: 280° C.
Ionization chamber temperature: 250° C.
EM voltage: 1500 eV
Range of mass to be measured: Range of m/z=29 to 800
Sample to be injected: 2 w/v % acetonitrile solution of sample (1 mass % NMP solution of 4-BAAB composition) (acetonitrile solution in which 2 g of sample is contained in total volume of 100 mL)
Amount of sample to be injected: 1 μL

### [GC/MS Analysis of Polyamic Acid Composition]

For each sample (each polyamic acid composition diluted with NMP to a polyamic acid concentration of 1 mass %), GC/MS analysis of each polyamic acid composition was performed with the same method as in [GC/MS Analysis of 4-BAAB Composition] above except that a “2 w/v % acetonitrile solution of each polyamic acid composition diluted with NMP to a polyamic acid concentration of 1 mass %” was used as a sample to be injected. From the area value of a peak in the obtained GC/MS chart, the content of each impurity with respect to the total amount of each sample (unit: ppm by mass) was calculated.

### <Method of Preparing 4-BAAB Composition>

Hereinafter, each of methods of preparing 4-BAAB compositions M1 to M7 used in Examples and Comparative Examples will be described. 4-Nitrophenyl-4-nitrobenzoate as a raw material was synthesized with the following method.

### [Method of Synthesizing 4-Nitrophenyl-4-Nitrobenzoate]

In a three-necked round-bottom flask, 14 g of 4-nitrophenol (“N0220” manufactured by Tokyo Chemical Industry Co., Ltd.) was dissolved in 300 mL of methyl ethyl ketone, and then 15.5 mL of triethylamine was added to obtain a solution Sₚh. Separately, 18.6 g of 4-nitrobenzoyl chloride (“N0176” manufactured by Tokyo Chemical Industry Co., Ltd.) was dissolved in 150 mL of 1,4-dioxane to obtain a solution S_{be}. Next, the solution Sₚₕ in the flask was cooled to a temperature of 0° C., and then the solution S_{be} was added dropwise to the solution Sₚₕ over 1 hour while stirring the solution Sₚₕ. Next, the flask contents were stirred for 3 hours under an atmosphere at a temperature of 23° C., and then the precipitated salt was separated by filtration to obtain a uniform solution. Next, the solvent was distilled off from the obtained solution using an evaporator to obtain a powder. Next, the obtained powder was washed twice with a 5 mass % aqueous sodium hydrogen carbonate solution, then washed twice with distilled water, and dried at a temperature of 80° C. for 12 hours under reduced pressure to obtain 4-nitrophenyl-4-nitrobenzoate.

### [Preparation of 4-BAAB Composition M7]

Into a three-necked round-bottom flask, 15 g of FeSO₄·7-H₂O, 30 g of methanol, and 30 g of distilled water were put, the flask contents were stirred, and then 5 g of 4-nitrophenyl-4-nitrobenzoate was added into the flask. Next, under an atmosphere at a temperature of 100° C., the flask contents were refluxed for 30 minutes while stirred, 25 g of potassium hydroxide (KOH) was then put into the flask, and the flask contents were further stirred for 30 minutes. Next, the flask contents were transferred to a separating funnel, and then an operation of adding 100 g of toluene into the separating funnel to extract an organic layer was repeated 3 times. Toluene in the obtained organic layer was volatilized, and then the organic layer was dried under reduced pressure at a temperature of 70° C. for 12 hours to obtain a powder P1. The obtained powder P1 was recrystallized using a mixed solvent of chloroform and ethanol (mass ratio: chloroform/ethanol=70/30). Next, the obtained precipitate was washed with ethanol and dried under reduced pressure at a temperature of 70° C. for 12 hours to obtain a 4-BAAB composition M7.

### [Preparation of 4-BAAB Composition M5]

A powder P1 was obtained with the same method as in [Preparation of 4-BAAB Composition M7] above, and then the obtained powder P1 was dissolved in dimethylacetamide in a three-necked round-bottom flask. Next, a small amount of activated carbon was added to the obtained dimethylacetamide solution (solid content concentration: 10 mass %), and the flask contents were stirred for 3 hours under an atmosphere at a temperature of 50° C. Next, the activated carbon was separated by filtration from the flask contents, the solvent was then distilled off from the obtained dimethylacetamide solution, and the resultant was dried under reduced pressure at a temperature of 70° C. for 12 hours to obtain a 4-BAAB composition M5.

### [Preparation of 4-BAAB Composition M6]

The 4-BAAB composition M5 obtained with the above procedure was recrystallized using a mixed solvent of chloroform and ethanol (mass ratio: chloroform/ethanol=70/30). Next, the obtained precipitate was washed with ethanol and dried under reduced pressure at a temperature of 70° C. for 12 hours to obtain a 4-BAAB composition M6.

### [Preparation of 4-BAAB Composition M4]

4-Nitrophenyl-4-nitrobenzoate was dissolved in dimethylacetamide in a three-necked round-bottom flask. Next, a small amount of activated carbon was added to the obtained dimethylacetamide solution (solid content concentration: 10 mass %), and the flask contents were stirred for 3 hours under an atmosphere at a temperature of 50° C. Next, the activated carbon was separated by filtration from the flask contents, the solvent was then distilled off from the obtained dimethylacetamide solution, and subsequently, the resultant was dried under reduced pressure at a temperature of 70° C. for 12 hours to obtain a powder P2. Next, 15 g of FeSO₄·7-H₂O, 30 g of methanol, and 30 g of distilled water were put into a three-necked round-bottom flask, the flask contents were stirred, and then 5 g of the powder P2 was added into the flask. Next, under an atmosphere at a temperature of 100° C., the flask contents were refluxed for 30 minutes while stirred, 25 g of potassium hydroxide (KOH) was then put into the flask, and the flask contents were further stirred for 30 minutes. Next, the flask contents were transferred to a separating funnel, and then an operation of adding 100 g of toluene into the separating funnel to extract an organic layer was repeated 3 times. Toluene in the obtained organic layer was volatilized, and then the organic layer was dried under reduced pressure at a temperature of 70° C. for 12 hours to obtain a 4-BAAB composition M4.

### [Preparation of 4-BAAB Composition M3]

The 4-BAAB composition M4 obtained with the above procedure was recrystallized using a mixed solvent of chloroform and ethanol (mass ratio: chloroform/ethanol=70/30). Next, the obtained precipitate was washed with ethanol and dried under reduced pressure at a temperature of 70° C. for 12 hours to obtain a 4-BAAB composition M3.

### [Preparation of 4-BAAB Composition M2]

4-Nitrophenyl-4-nitrobenzoate was recrystallized using a mixed solvent of chloroform and ethanol (mass ratio: chloroform/ethanol=70/30). Next, the obtained precipitate was washed with ethanol and dried under reduced pressure at a temperature of 70° C. for 12 hours to obtain a powder P3. Next, the obtained powder P3 was dissolved in dimethylacetamide in a three-necked round-bottom flask. Next, a small amount of activated carbon was added to the obtained dimethylacetamide solution (solid content concentration: 10 mass %), and the flask contents were stirred for 3 hours under an atmosphere at a temperature of 50° C. Next, the activated carbon was separated by filtration from the flask contents, the solvent was then distilled off from the obtained dimethylacetamide solution, and subsequently, the resultant was dried under reduced pressure at a temperature of 70° C. for 12 hours to obtain a powder P4. Next, 15 g of FeSO₄·7-H₂O, 30 g of methanol, and 30 g of distilled water were put into a three-necked round-bottom flask, the flask contents were stirred, and then 5 g of the powder P4 was added into the flask. Next, under an atmosphere at a temperature of 100° C., the flask contents were refluxed for 30 minutes while stirred, 25 g of potassium hydroxide (KOH) was then put into the flask, and the flask contents were further stirred for 30 minutes. Next, the flask contents were transferred to a separating funnel, and then an operation of adding 100 g of toluene into the separating funnel to extract an organic layer was repeated 3 times. Toluene in the obtained organic layer was volatilized, and then the organic layer was dried under reduced pressure at a temperature of 70° C. for 12 hours to obtain a 4-BAAB composition M2.

### [Preparation of 4-BAAB Composition M1]

4-Nitrophenyl-4-nitrobenzoate was dissolved in dimethylacetamide in a three-necked round-bottom flask. Next, a small amount of activated carbon was added to the obtained dimethylacetamide solution (solid content concentration: 10 mass %), and the flask contents were stirred for 3 hours under an atmosphere at a temperature of 50° C. Next, the activated carbon was separated by filtration from the flask contents, the solvent was then distilled off from the obtained dimethylacetamide solution, and subsequently, the resultant was dried under reduced pressure at a temperature of 70° C. for 12 hours to obtain a powder P5. Next, the obtained powder P5 was recrystallized using a mixed solvent of chloroform and ethanol (mass ratio: chloroform/ethanol=70/30). Next, the obtained precipitate was washed with ethanol and dried under reduced pressure at a temperature of 70° C. for 12 hours to obtain a powder P6. Next, 15 g of FeSO₄·7-H₂O, 30 g of methanol, and 30 g of distilled water were put into a three-necked round-bottom flask, the flask contents were stirred, and then 5 g of the powder P6 was added into the flask. Next, under an atmosphere at a temperature of 100° C., the flask contents were refluxed for 30 minutes while stirred, 25 g of potassium hydroxide (KOH) was then put into the flask, and the flask contents were further stirred for 30 minutes. Next, the flask contents were transferred to a separating funnel, and then an operation of adding 100 g of toluene into the separating funnel to extract an organic layer was repeated 3 times. Toluene in the obtained organic layer was volatilized, and then the organic layer was dried under reduced pressure at a temperature of 70° C. for 12 hours to obtain a 4-BAAB composition M1.

Table 1 shows the Gardner color, the APAH, the content of the aminophenol in the 4-BAAB composition, the content of the methyl aminobenzoate in the 4-BAAB composition, and the content of the ethyl aminobenzoate in the 4-BAAB composition for the 4-BAAB compositions M1 to M7.

TABLE 1

| | | | Content of each impurity in 4-BAAB | | |
|---|---|---|---|---|---|
| | | | composition [mass %] | | |
| | | | | Methyl | Ethyl |
| 4-BAAB | Gardner | | Amino- | amino- | amino- |
| composition | color | APAH | phenol | benzoate | benzoate |
| M1 | 0.1 | 12 | 0.53 | 0.11 | 0.03 |
| M2 | 0.2 | 24 | 0.52 | 0.03 | 0.02 |
| M3 | 1.9 | 148 | 0.56 | 0.15 | 0.04 |
| M4 | 3.4 | 217 | 0.48 | 0.65 | 0.17 |
| M5 | 3.6 | 233 | 0.69 | 0.42 | 0.14 |
| M6 | 3.9 | 266 | 0.71 | 0.03 | 0.03 |
| M7 | 4.6 | 316 | 1.34 | 0.02 | 0.04 |

### <Preparation of Polyimide Film>

Hereinafter, the methods for preparing a polyimide film (laminate) in Examples and Comparative Examples will be described. The polyamic acid compositions for use in preparation of the polyimide films were each prepared in a nitrogen atmosphere.

### Example 1

Into a 300 mL glass separable flask equipped with a stirrer including a stainless steel stirring rod and with a nitrogen inlet tube, 56.6 g of NMP was put as an organic solvent for polymerization. Then, 4.393 g of 4-BAAB composition M1 was put into the flask and dissolved while the flask contents were stirred. Then, 5.607 g of s-BPDA was added to the flask contents, and then the flask contents were stirred for 24 hours under an atmosphere at a temperature of 23° C. to obtain a polyamic acid composition. The obtained polyamic acid composition was applied using a spin coater onto a glass substrate manufactured by Corning Incorporated (trade name: Eagle XG, material: alkali-free glass, thickness: 0.7 mm, size: 100 mm×100 mm), and the resulting product was heated at 80° C. for 30 minutes in the air, and then heated at 430° C. for 30 minutes in a nitrogen atmosphere to obtain a laminate including a polyimide film having a thickness of 10 μm on the glass substrate (laminate of Example 1).

### Examples 2 to 7 and Comparative Examples 1 to 6

Laminates of Examples 2 to 7 and Comparative Examples 1 to 6 were obtained with the same method as in Example 1, except that the kind of the used acid dianhydride, the ratio of each acid dianhydride put into the flask, the kind of the used 4-BAAB composition, and the ratio of each 4-BAAB composition put into the flask were changed as shown in Table 2. In Examples 2 to 7 and Comparative Examples 1 to 6, the total substance amount of acid dianhydrides used in preparing the polyamic acid composition was the same as the total substance amount of acid dianhydrides used in preparing the polyamic acid composition in Example 1.

For Examples 1 to 7 and Comparative Examples 1 to 6, Table 2 shows the kind of the used acid dianhydride, the ratio of each acid dianhydride put into the flask, the kind of the used 4-BAAB composition, and the ratio of each 4-BAAB composition put into the flask. For Examples 1 to 7 and Comparative Examples 1 to 6, Table 3 shows the Gardner color of the used polyamic acid composition, the APAH of the used polyamic acid composition, the content of the aminophenol in the used polyamic acid composition, the content of the methyl aminobenzoate in the used polyamic acid composition, the content of the ethyl aminobenzoate in the used polyamic acid composition, the YI of the polyimide film, the 400 nm transmittance and the 450 nm transmittance of the polyimide film, and the internal stress.

In Table 2, “-” means that the relevant component was not used. In Table 3, “-” means that measurement was not performed. In Table 2, the numerical value in the column of “Acid dianhydride” is the content (unit: mol %) of each acid dianhydride with respect to the total amount (100 mol %) of the used acid dianhydrides. In Table 2, the numerical value in the column of “4-BAAB composition” is the ratio (unit: mol %) of 4-BAAB in the used 4-BAAB composition put into the flask with respect to the total amount (100 mol %) of the used acid dianhydrides. In each of Examples 1 to 7 and Comparative Examples 1 to 6, the molar fraction of each residue in the polyamic acid in the prepared polyamic acid composition was equal to the molar fraction of each monomer (each monomer corresponding to each residue) used in synthesis of the polyamic acid.

TABLE 2

| | Acid dianhydride [mol %] | | | | | 4-BAAB composition [mol %] | | | | | | |
|---|---|---|---|---|---|---|---|---|---|---|---|---|
| | s-BPDA | a-BPDA | BPAF | SFDA | ODPA | M1 | M2 | M3 | M4 | M5 | M6 | M7 |
| Example 1 | 100 | — | — | — | — | 101 | — | — | — | — | — | — |
| Example 2 | 100 | — | — | — | — | — | 101 | — | — | — | — | — |
| Example 3 | 100 | — | — | — | — | — | — | 101 | — | — | — | — |
| Example 4 | 85 | 10 | — | 5 | — | 101 | — | — | — | — | — | — |
| Example 5 | 90 | — | 10 | — | — | 101 | — | — | — | — | — | — |
| Example 6 | 70 | — | — | 30 | — | 101 | — | — | — | — | — | — |
| Example 7 | 85 | — | — | 5 | 10 | 101 | — | — | — | — | — | — |
| Comparative | 100 | — | — | — | — | — | — | — | 101 | — | — | — |
| Example 1 | | | | | | | | | | | | |
| Comparative | 100 | — | — | — | — | — | — | — | — | 101 | — | — |
| Example 2 | | | | | | | | | | | | |
| Comparative | 100 | — | — | — | — | — | — | — | — | — | 101 | — |
| Example 3 | | | | | | | | | | | | |
| Comparative | 100 | — | — | — | — | — | — | — | — | — | — | 101 |
| Example 4 | | | | | | | | | | | | |
| Comparative | 90 | — | 10 | — | — | — | — | — | — | — | — | 101 |
| Example 5 | | | | | | | | | | | | |
| Comparative | 85 | 10 | — | 5 | — | — | — | — | — | — | — | 101 |
| Example 6 | | | | | | | | | | | | |

TABLE 3

| | | | Content of each impurity | | | | | | |
|---|---|---|---|---|---|---|---|---|---|
| | Gardner | | in polyamic acid | | | | | | |
| | color of | APAH of | composition [ppm by mass] | | | | 400 nm | 450 nm | |
| | polyamic | polyamic | | Methyl | Ethyl | | Trans- | Trans- | Internal |
| | acid | acid | Amino- | amino- | amino- | | mittance | mittance | stress |
| | composition | composition | phenol | benzoate | benzoate | YI | [%] | [%] | [MPa] |
| Example 1 | 0.0 | 0 | 23 | 0.03 | 0.000008 | 17 | 9 | 70 | 2 |
| Example 2 | 0.0 | 0 | 23 | 0.01 | 0.000001 | 17 | 9 | 71 | 1 |
| Example 3 | 0.1 | 6 | 24 | 0.04 | 0.000015 | 20 | 8 | 68 | 2 |
| Example 4 | — | — | 23 | 0.03 | 0.000008 | 13 | 11 | 76 | 8 |
| Example 5 | — | — | 23 | 0.03 | 0.000008 | 13 | 10 | 77 | 5 |
| Example 6 | — | — | 23 | 0.03 | 0.000008 | 13 | 15 | 75 | 1 |
| Example 7 | — | — | 23 | 0.03 | 0.000008 | 14 | 11 | 76 | 4 |
| Comparative | 0.4 | 43 | 21 | 0.14 | 0.002317 | 23 | 7 | 68 | 2 |
| Example 1 | | | | | | | | | |
| Comparative | 0.5 | 54 | 30 | 0.13 | 0.000177 | 23 | 7 | 65 | 3 |
| Example 2 | | | | | | | | | |
| Comparative | 0.4 | 42 | 31 | 0.01 | 0.000003 | 24 | 7 | 64 | 3 |
| Example 3 | | | | | | | | | |
| Comparative | 1.0 | 89 | 59 | 0.01 | 0.000005 | 27 | 7 | 61 | 2 |
| Example 4 | | | | | | | | | |
| Comparative | — | — | 59 | 0.01 | 0.000005 | 24 | 7 | 70 | 3 |
| Example 5 | | | | | | | | | |
| Comparative | — | — | 59 | 0.01 | 0.000005 | 23 | 7 | 66 | 10 |
| Example 6 | | | | | | | | | |

In Examples 1 to 7, the content of the 4-BAAB residue in the polyamic acid contained in the used polyamic acid composition was 70 mol % or more with respect to the total amount of diamine residues included in the polyamic acid. As shown in Table 3, in Examples 1 to 7, the content of the aminophenol in the used polyamic acid composition was 1 ppm by mass or more and 30 ppm by mass or less. In Examples 1 to 7, the content of the methyl aminobenzoate in the used polyamic acid composition was 0.01 ppm by mass or more and 0.10 ppm by mass or less.

As shown in Table 3, the YI was 20 or less in Examples 1 to 7. Thus, the polyimide films obtained in Examples 1 to 7 were excellent in transparency. In Examples 1 to 7, the internal stress was 30 MPa or less. Thus, in the laminates obtained in Examples 1 to 7, reduction of the internal stress was achieved.

As shown in Table 3, in Comparative Examples 3 to 6, the content of the aminophenol in the used polyamic acid composition was more than 30 ppm by mass. In Comparative Examples 1 and 2, the content of the methyl aminobenzoate in the used polyamic acid composition was more than 0.10 ppm by mass.

As shown in Table 3, the YI was more than 20 in Comparative Examples 1 to 6. Thus, the polyimide films obtained in Comparative Examples 1 to 6 were not excellent in transparency.

From the above results, it has been shown that according to one or more embodiments of the present invention, it is possible to provide a polyamic acid composition that enables production of a polyimide excellent in transparency while the internal stress is reduced.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A polyamic acid composition comprising:
a polyamic acid;
an organic solvent;
an aminophenol; and
a methyl aminobenzoate,
wherein:
the polyamic acid comprises a 4-aminophenyl-4-aminobenzoate residue as a diamine residue,
a content of the 4-aminophenyl-4-aminobenzoate residue is 70 mol % or more with respect to a total amount of diamine residues included in the polyamic acid,
a content of the aminophenol, obtained by gas chromatography-mass spectrometry using a sample obtained by diluting the polyamic acid composition to a concentration of the polyamic acid of 1 mass %, is 1 ppm by mass or more and 30 ppm by mass or less with respect to a total amount of the sample, and
a content of the methyl aminobenzoate, obtained by gas chromatography-mass spectrometry using a sample obtained by diluting the polyamic acid composition to a concentration of the polyamic acid of 1 mass %, is 0.01 ppm by mass or more and 0.10 ppm by mass or less with respect to a total amount of the sample.

2. The polyamic acid composition according to claim 1, wherein:
a Gardner color of the polyamic acid composition is 0.3 or less,
a Hazen color of the polyamic acid composition is 10 or less, and
the Gardner color and the Hazen color are measured with a cell having an optical path length of 1 cm using a sample obtained by diluting the polyamic acid composition to a concentration of the polyamic acid of 1 mass %.

3. The polyamic acid composition according to claim 1, wherein the polyamic acid comprises one or more tetracarboxylic dianhydride residues selected from the group consisting of tetravalent organic groups represented by Chemical Formula (1) described below, tetravalent organic groups represented by Chemical Formula (2) described below, tetravalent organic groups represented by Chemical Formula (3) described below, tetravalent organic groups represented by Chemical Formula (4) described below, tetravalent organic groups represented by Chemical Formula (5) described below, tetravalent organic groups represented by Chemical Formula (6) described below, tetravalent organic groups represented by Chemical Formula (7) described below, tetravalent organic groups represented by Chemical Formula (8) described below, tetravalent organic groups represented by Chemical Formula (9) described below, and tetravalent organic groups represented by Chemical Formula (10) described below:

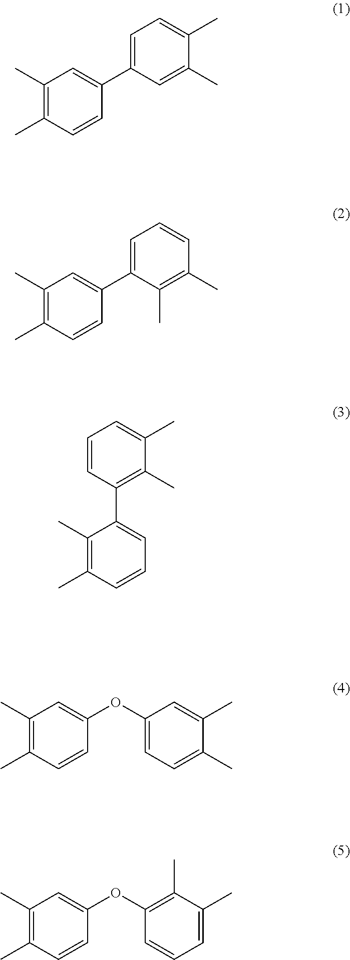

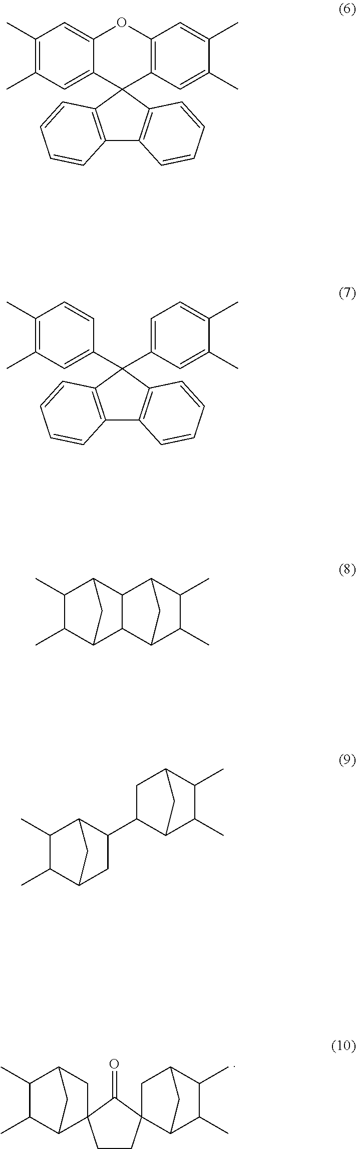

4. A polyimide which is an imidized product of the polyamic acid comprised in the polyamic acid composition according to claim 1.

5. A polyimide film comprising the polyimide according to claim 4.

6. The polyimide film according to claim 5, having a yellowness index of 20 or less.

7. The polyimide film according to claim 5, having a transmittance of light having a wavelength of 400 nm of 88% or more.

8. A laminate comprising a support and the polyimide film according to claim 5.

9. The laminate according to claim 8, wherein:
the support is a glass substrate, and
an internal stress between the polyimide film and the glass substrate is 30 MPa or less.

10. An electronic device comprising the polyimide film according to claim 5 and an electronic element disposed on the polyimide film.

11. A method of producing the polyamic acid composition according to claim 1, the method comprising:
a step S1 of reacting a diamine with a tetracarboxylic dianhydride in an organic solvent,
wherein:
the diamine comprises 4-aminophenyl-4-aminobenzoate,
a content of the 4-aminophenyl-4-aminobenzoate is 70 mol % or more with respect to a total amount of the diamine,
the 4-aminophenyl-4-aminobenzoate is used as a raw material monomer containing an impurity and subjected to the step S1,
the impurity comprises aminophenol and methyl aminobenzoate,
a Gardner color of the polyamic acid composition is 3.0 or less,
a Hazen color of the polyamic acid composition is 200 or less, and
the Gardner color and the Hazen color are measured with a cell having an optical path length of 1 cm using a 1 mass % N-methyl-2-pyrrolidone solution of the raw material monomer.

12. The method according to claim 11, wherein:
a content of the aminophenol in the raw material monomer is 0.60 mass % or less with respect to a total amount of the 4-aminophenyl-4-aminobenzoate, and
a content of the methyl aminobenzoate in the raw material monomer is 0.60 mass % or less with respect to the total amount of the 4-aminophenyl-4-aminobenzoate.
